(19) United States
(12) Patent Application Publication
(10) Pub. No.: US 2009/0203846 A1
(43) Pub. Date: Aug. 13, 2009

(54) KETONE-RESISTANT FKM/TPV BLENDS

(75) Inventors: Edward Hosung Park, Saline, MI (US); Francis Joseph Walker, Tecumseh, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 12/028,413

(22) Filed: Feb. 8, 2008

(51) Int. Cl. C08J 3/28; C08L 27/12; C08F 214/26

(52) U.S. Cl. 525/198; 525/200; 525/199

(57) ABSTRACT

Thermoplastic vulcanizate compositions prepared from fluorothermoplastic matrix and dispersed fluoroelastomeric regions, and articles comprising the thermoplastic vulcanizate, exhibiting improved resistance to polar organic solvents.

### FIELD

The present disclosure relates to thermoprocessable, polymer blend compositions containing cured fluorocarbon elastomers. It also relates to seal and gasket type material made from the compositions and methods for their production by dynamic vulcanization techniques.

### BACKGROUND

The statements in this section merely provide background information related to the present disclosure and may not constitute prior art.

Cured fluoroelastomers are useful in a wide variety of applications and find particular utility in sealing members that contact volatile or caustic fluids. For example, fluoroelastomers are used in seals, such as O-rings and gaskets, in the petrochemical paints and coatings industry, and in automotive fuel systems. Thus, fluoroelastomer seals are commonly found in spray painting equipment and gasoline and diesel automotive fuel tanks and lines.

Yet, the most chemically resistant perfluoroelastomers are quite expensive and can swell or degrade in polar solvents, such as ketones and alcohols. In light of this drawback, the growing use of alcohol-containing and biodiesel automotive fuels has, in a number of cases, resulted in disintegration of fluoroelastomer seals designed for use with petrochemical fuels. In addition, fluoroelastomers have not found widespread use in industrial chemistry and space vehicle fuel systems, because of the poor resistance of fluoroelastomers to polar organic solvents and because they exhibit creep under high pressures, thereby resulting in fluid-type flow of the seal away from the sealed joint. Consequently, polytetrafluoroethylene (PTFE) is traditionally used in such applications, even though PTFE-type thermoplastics are rigid and do not offer the advantageous properties provided by elastomers. These limitations of fluoroelastomers reveal a need and opportunity to provide fluoropolymeric materials adaptable to a wider range of chemical applications.

As a result, it would be advantageous to obtain improved materials that can provide the desirable properties of fluoroelastomers, yet can offer improved resistance to polar organic solvents, such as ketones and alcohols, and improved resistance to creep under pressure.

### SUMMARY

The present disclosure provides improved materials that can offer desirable properties of fluoroelastomers, yet can also offer improved resistance to polar solvents, such as ketones and alcohols, as well as improved resistance to creep under pressure. The present invention further provides such improved materials that also offer the flexible processability of thermoplastics, which most elastomers lack. The present invention thereby makes possible both less expensive replacements for fluoroelastomers and the extension of fluorelastomer-containing materials to a wider range of applications. Various embodiments described herein further provide:

Ketone-solvent-resistant FKM-TPV blends composed of (A) from about 35% to 99% by weight of fluorothermoplastic matrix and, dispersed therein, from 1% to about 65% by weight of fluoroelastomer regions of about 50 um or less in average size, with (1) the matrix including at least one fluorothermoplastic polymer, having from about 45% to about 75% by weight fluorine content and at least 40% crystallinity, that is selected from the group consisting of: thermoplastic copolymers of any of TFE, HFP, CTFE, CPFP, and VDF with one another, with PAVE, E, and/or P, and with both; and thermoplastic PVDF; and one or more additive(s) that provide a total of from 0% to about 20% by weight of the matrix; and with (2) the fluoroelastomer regions independently including one or more fluoroelastomeric polymer having from about 60% to about 75% by weight fluorine content that is selected from the group consisting of elastomeric copolymers of any of TFE, PAVE/AE, and VDF with one another, with E and/or P, with one or more cure-site monomer, and with a combination thereof; one or more additive(s) that provide a total of from 0% to about 20% by weight of the fluoroelastomer region; and the blend include one or more FKM-TPV blend additive(s) that provide a total of from 0% to about 20% by weight of the FKM-TPV blend; wherein the blend exhibits less than 20% swelling during immersion in a ketone-type solvent at 20° C., for 7 days.

Such blends in which the dispersed fluoroelastomer regions make up from about 65% to about 50% by weight, and the fluorothermoplastic matrix makes up about 35% to about 50% by weight of the composition; or in which the dispersed fluoroelastomer regions make up from about 50% to about 1% by weight, and the fluorothermoplastic matrix makes up about 50% to about 99% by weight.

Such blends in which the fluoroelastomer regions include cure-site-monomer (CSM)-residue-containing fluoroelastomeric polymer(s) that are chemically cross-linked through those CSM residues, or are radiation cross-linked; such blends in which the fluoroelastomer regions are made of cure-site-monomer (CSM)-residue-free fluoroelastomeric polymer(s) that are radiation cross-linked; such blends in which fluoroelastomeric polymer(s) of the fluoroelastomer regions are radiation cross-linked to fluorothermoplastic polymers of the matrix; and such blends in which the fluorothermoplastic polymer(s) are radiation cross-linked.

Processes for preparing such FKM-TPV blends, involving: (A) mixing the fluorothermoplastic and CSM-containing fluoroelastomer with the additives, the additives including curing agent(s) in contact with the fluoroelastomer, wherein the mixing is performed under an elevated temperature above the Vicat softening point of the fluorothermoplastic; (B) continuing to mix until the average diameter of the fluoroelastomer regions is about 50 μm or less, thereby forming a mixed blend; and then (C) irradiating the mixed blend to induce cross-links in the fluorothermoplastic, thereby forming an irradiated blend.

Processes for preparing such FKM-TPV blends, involving: (A) mixing the fluorothermoplastic and fluoroelastomer with the additives, in which combination either the fluoroelastomer is CSM-free or the additives do not comprise a curing agent therefor, the mixing being performed under an elevated temperature above the Vicat softening point of the fluorothermoplastic; (B) continuing to mix until the average diameter of the fluoroelastomer regions is about 50 μm or less, thereby forming a mixed blend; and then (C) irradiating the mixed blend to induce cross-links in the fluorothermoplastic, and in the fluoroelastomer, thereby forming an irradiated blend.

Such processes of either type in which the mixing is performed by extrusion and/or employing dynamic vulcanization; such processes that further involve shaping the mixed blend after step (B) and before step (C), to form an article (e.g., by molding), or shaping the irradiated blend (e.g., by cutting or abrading) after step (C), to form an article.

Articles comprising such an FKM-TPV blend; and exemplary articles including sheets, stoppers, seals, gaskets, O-rings, pottings, radial shaft seals, and static seals.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 presents a ternary diagram defined by points 111, 112, and 113, which respectively represent 100% HFP (111), 100% TFE (112), and 100% VDF (113); the 0% line for each of these monomers is respectively 0% HFP (112-113), 0% TFE (111-113), and 0% VDF (111-112). Region 101 defines HFP/VDF-containing FKM polymers that are useful as fluoroelastomers in some embodiments hereof.

FIGS. 2 and 3 present tables of results of fluid immersion tests of fluorothermoplastic (“FKM-terpolymer”), fluoroelastomers, and thermoplastic vulcanizate (TPV) blends thereof, using common fuels and industrial solvents. FIG. 2 compares TPV with the fluorothermoplastic and Table 3 with the fluoroelastomers.

### DETAILED DESCRIPTION

The following description is merely exemplary in nature and is not intended to limit the present disclosure, application, or uses. References cited herein are incorporated by reference.

In various embodiments hereof, a composite material is provided in which fluoroelastomer regions are dispersed as a discontinuous phase in a matrix, i.e. the continuous phase, prepared from fluorothermoplastic polymers. The composite material is cured to form a thermoplastic vulcanizate in which the fluoroelastomer regions are vulcanized and the fluorothermoplastic matrix is cross-linked. In various embodiments, the curing process can be performed either before or after the composite material has been shaped to form an article, e.g., a gasket, seal, O-ring, or potting element. At initiation of the step of inducing cross-linking in the fluorothermoplastic matrix, the fluoroelastomer regions therein can be entirely uncured, partially cured, or substantially fully cured.

Similarly, when the fluoroelastomer is dispersed into the fluorothermoplastic, it can be entirely uncured or partially cured. In various embodiments, the fluoroelastomer can be in uncured or partially cured form when dispersed into the matrix. Where regions of fluoroelastomer dispersed in the matrix are uncured or partially cured, these can be further or fully cured before or during the step of inducing cross-linking in the fluorothermplastic phase.

The weight ratio of fluorothermoplastic to fluoroelastomer in the material can be about 1:10 to about 10:1, typically from about 1:2 to about 4:1. In various embodiments, the fluoroelastomer can make up at least or about 20, 25, or 30 wt. %; and up to about 60, 55, or 50 wt. % of the fluoropolymer content of the material.

The thermoplastic vulcanizate can be exposed to radiation in order to form cross-links in the thermoplastic, and in some embodiments also to increase the level of cross-links in the fluoroelastomer. In various embodiments, this exposure to radiation induces the formation of cross-links between the fluoroelastomer regions and the fluorothermoplastic matrix, according to the interlink structure A-B, even without the use of cure-site monomers in either phase.

The thermoplastic vulanizate exhibits excellent resistance to polar organic solvents, such as ketones and/or alcohols, thereby providing a useful gasketing and sealing material. The irradiated thermoplastic vulcanizate hereof, exhibits even further increased resistance to such solvents. Similarly articles made of the material have been unexpectedly found to exhibit a high resistance to deformation (e.g., swelling) or degradation (e.g., dissolution) in ketone solvents, and, in various embodiments, alcohol solvents.

### Fluoropolymers

The compositions hereof comprise fluoropolymers. The acronyms listed in Table 1 are used herein to describe monomers from which a fluoropolymer hereof can be obtained, in the case of either a fluoroelastomer or a fluorothermoplastic hereof.

TABLE 1
Acronyms

| Acronym | Meaning |
|---|---|
| CTFE | Chlorotrifluoroethylene |
| CPFP | Chloropentafluoropropylene |
| CSM | Cure-site monomer |
| E | Ethylene (i.e. ethene), when not combined in a larger acronym |
| P | Propylene (i.e. propene), when not combined in a larger |
| | acronym |
| E/P | Ethylene/propylene: ethylene or propylene or both monomers |
| HFP | Hexafluoropropylene |
| PAAE | Perfluoro(alkyl allyl ether) |
| PAVE | Perfluoro(alkyl vinyl ether) |
| PAV/AE | Perfluoro(alkyl vinyl/allyl ether), i.e. PAVE or PAAE or |
| | both monomers |
| TFE | Tetrafluoroethylene |
| VDF | Vinylidene fluoride |

In various embodiments, useful alkyl groups can be C₁-C₆ alkyl groups, and these can include any one or more of: methyl, ethyl, n-propyl, iso-propyl, n-butyl, sec-butyl, iso-butyl, tert-butyl, n-pentyl, iso-pentyl, sec-pentyl, tert-pentyl, neopentyl, n-hexyl, iso-hexyl, sec-hexyl, tert-hexyl, neohexyl, cyclobutyl, cyclopentyl, or cyclohexyl.

As used herein, a perfluoro(alkyl allyl ether) monomer means a perfluoro(alkyl allyl ether) that contains from 4 to 9 carbon atoms. As used herein, a perfluoro(alkyl vinyl ether) monomer means a perfluoro(alkyl vinyl ether) that contains from 3 to 8 carbon atoms.

In perfluoro(alkyl vinyl/allyl ether) monomers (PAV/AE) hereof, the perfluoroalkyl group can be any of the perfluoro(C₁-C₆ alkyl) or perfluoro(C₄-C₆ cycloalkyl) groups; in various embodiments, such perfluoroalkyl group(s) can be perfluoro(C1, C2, nC3, nC4, nC5, or nC6 alkyl) group(s), and particularly perfluoro(C1, C2, or nC3 alkyl) group(s). For example, see those monomers described in U.S. Pat. No. 6,255,535 to Moore et al., herein incorporated by reference.

One or more than one PAV/AE monomer can be used to prepare a PAV/AE monomer residue-containing polymer hereof; in some embodiments, this can be a combination of a PAVE monomer and a PAAE monomer, a combination of PAVE monomers, a combination or PAAE monomers, or both. In various embodiments, a combination of PAVE monomers can be used. In some embodiments, a single type of PAVE monomer will be the only PAV/AE monomer used in forming the copolymer. Of PAVE monomers, perfluoro(methyl vinyl ether) and perfluoro(propyl vinyl ether) are particularly useful.

As used herein, those polymer names that internally recite the names of monomers useful to form the polymers are not limiting as to the source of the polymers, but are used as a convenient way to specify the structural identity of the polymer. Thus, a polymer of a given identity is one obtainable by reaction of the recited monomers, and can likewise be obtained by any other route in the art that is useful for forming a polymer of that structure.

The composition of polymers hereof is described with reference to the mole percent (mol. %), and in some cases with reference to the weight percent (wt. %), of the components of the polymers. Many polymers useful herein are copolymers, e.g., dipolymers, tripolymers, or tetrapolymers (aside from cure-site-monomer content, if any). The format of the copolymers can be any useful formate known in the art. For example, copolymers having random, statistical, alternating, or block copolymer chains can be used; and polymer architectures can be, e.g., linear, graft, branched (simple-branched, e.g., having about or fewer than one branch per thousand main-chain monomer residues), or comb-, brush-, or hyper-branched.

### Fluorothermoplastics

The matrix (continuous phase) of a composite material hereof is prepared from fluorothermoplastic, i.e. a fluoropolymer material that has the characteristics described below, that exhibits a glass transition temperature (Tg) below the melting temperature (Tm, e.g., crystalline Tm) thereof, and that at a temperature between its Tg and Tm is semi-crystalline and exhibits plasticity when in a non-crosslinked state. In various embodiments, a fluorothermoplastic hereof can be one that exhibits about or more than 40% crystallinity (below its melting temperature), as measured by determining the heat of fusion by differential scanning calorimetry, e.g., according to test method ASTM D-3417 or ASTM E-793-85. In some embodiments, the crystallinity can be up to, about, or more than 45, 50, 55, 60, 65, or 70%; in various embodiments, the crystallinity can be about or less than 80, 75, or 70%; or from about 45 to about 70%. Crystallinity can also be determined by X-ray diffraction. In various embodiments, the fluorothermoplastic can have a softening or melting point that is from about 80 to about 350° C. In various embodiments, a fluorothermoplastic for use herein can have a Tg that is in the range of about −120° C. to about +20° C., and typically about −95° C. to about −20° C.

Useful fluorothermoplastics can have from about 45% to about 75 wt. %, and more typically up to about 72 wt. % fluorine content. These can be formed as copolymers of any of TFE, HFP, CTFE, CPFP, and VDF with one another, with PAVE, E, and/or P; thermoplastic PVDF is also useful in some embodiments hereof. Examples of useful fluorothermoplastics include those listed in Table 2. TFE-CTFE thermoplastics with high crystallinity (>40%) can also be used.

TABLE 2
Exemplary Fluorthermoplastics

| Fluorothermoplastic (Family/Example) | Abbv. | Exemplary Commercial Types |
|---|---|---|
| Poly(TFE-co-HFP) | FEP | DuPont Teflon FEP, AGC (Asahi Glass Co.) Fluon |
| | | FEP, 3M Dyneon FEP |

Poly(TFE-co-PAVE)

| | | |
|---|---|---|
| Poly(TFE-co-PMVE) | MFA | Solvay-Solexis Solef MFA (formerly Hyflon MFA), |
| | | AGC Fluon MFA |
| Poly(TFE-co-PPVE) | PFA | DuPont Teflon PFA, Solvay-Solexis Solef PFA |
| | | (formerly Hyflon PFA), 3M Dyneon PFA |
| Poly(VDF) | PVDF | AtoFina Kynar PVDF, AGC Fluon PVDF, Solvay- |
| | | Solexis Solef PVDF (formerly Hylar) |

Poly(E/P-co-TFE)

| | | |
|---|---|---|
| Poly(E-co-TFE) | ETFE | DuPont Tefzel ETFE, AGC Fluon ETFE, 3M Dyneon |
| | | ETFE |

Poly(E/P-co-CTFE)

| | | |
|---|---|---|
| Poly(E-co-CTFE) | ECTFE | AGC Fluon ECTFE, Solvay-Solexis Solef ECTFE |
| | | (formerly Halar) |
| Poly(TFE-co-HFP-co-VDF) | THV | 3M Dyneon THV-200 |

Poly(E/P-co-HFP)

| | |
|---|---|
| poly(E-co-HFP) | PEHFP |

Poly(E/P-co-CPFP)

| | |
|---|---|
| poly(E-co-CPFP) | PECPFP |

In various embodiments, the fluorothermoplastic can be a perfluoropolymer, such as FEP, MFA, PFA, PVDF, or THV, or can contain non-perfluoro monomer residues, such as alkylene residues as in the case of ETFE, ECTFE, PEHFP, or PECPFP, or TFE-CTFE. In either case, a fluorothermoplastic polymer hereof can contain CSM monomer residues or can be CSM-free. In various embodiments, CSM-free fluorothermoplastic polymers can be used herein.

### Fluoroelastomers

The discontinuous phase of a composition hereof comprises a dispersion of fluoroelastomer regions within the fluorothermoplastic matrix. As used herein, “fluorelastomer” refers to elastomeric fluorine-containing polymers having the characteristics described below, and to polymeric materials comprising them, that, upon curing, can meet the criteria of: ASTM D1566, i.e. the material will retract to less than 1.5 times its original length within one minute after being stretched at room temperature to twice its original length and held for one minute before release; ASTM D412 (tensile set parameters), and ASTM D395 (elastic requirements for compression set).

Characteristics of useful fluoroelastomers hereof include the following. Example of useful fluoroelastomers include, e.g., FKM, FFKM, and FEPM fluoropolymers, e.g., as categorized under the ASTM D1418 standard (or respectively FPM, FFPM, and FEPM under the ISO 1629 standard), wherein the useful polymers typically contain about 65 mol. % or more fluorine content. In various embodiments, such polymers contain about or more than 66, 67, 68, 69, 70, 71, or 72 mol. %, and up to or about 75 mol. % fluorine. However, in embodiments of fluoroelastomers hereof that contain alkylene monomer residues, the fluorine content can be as low as 60 wt. %.

In various embodiments, fluoroelastomers hereof can have from about 60% to about 75 wt. %, and more typically up to about 72 wt. % fluorine content. These can be formed as copolymers of any of TFE, VI)F, and PAV/AE, with one another, and/or with E, P; or in some embodiments with HFP. Silicone-cross-linking group-terminated perfluoroalkylpolyethers are also useful in some embodiments hereof.

As used herein in describing non-CSM monomer content of fluoroelastomers, “alkylene” refers to residues of C₂-C₄ alkylenes, typically propylene and/or ethylene. The non-fluorinated alkylene residue content of fluoroelastomers hereof is typically 25% mol. % or less, generally about or less than 20, 15, 10 or 5 mol. %; and generally about or more than 1, 2, 3, 5, or 10 mol. %. Typical alkylene residue content can be from about 1 to about 15 mol. %, although an increased amount of alkylene residues can be present so as to provide a fluoroelastomer having as low as 60 wt. % fluorine content.

In various embodiments, a fluoroelastomer hereof can contain cure-site monomer (CSM) residues or can be CSM-free. In fluoroelastomers hereof that contain more than 70 mol. % fluorine, cure-site monomers can be used, but are optional; in those that contain 70 mol. % or less fluorine, CSM are typically present. In various embodiments, aside from CSM content, the fluoroelastomer can be a perfluoroelastomer.

### FKM

As used herein, “FKM” fluoroelastomer refers to those fluoroelastomers belonging to the ASTM “FKM” designation, and particularly those that comprise TFE and VDF residues and either or both of alkylene and PAV/AE residues. An FKM elastomer can contain or can be free of HFP monomer residues. Though any of FKM Types 1-5 can be used in various embodiments hereof, in some embodiments, a Type 2 or Type 5 FKM can be used. See D. Hertz, Jr, “Fluoroelastomers,” in K. C. Baranwal & H. L. Stephens (eds.), Basic Elastomer Technology, chapt. 11.D. (ACS 2001); and D. Hertz, Jr., Fluorine-Containing Elastomers (Seals Eastern, Inc.) (available on the World Wide Web at sealseastern.com/PDF/FluoroAcsChapter.pdf).

In FKM fluoroelastomers hereof, the mole ratio of TFE:VDF is generally from about 15:85 to about 70:30. In some embodiments, the FKM fluoroelastomer can contain cure site monomer residue(s). In various embodiments, the FKM fluoroelastomer can contain only TFE and VDF residues and either or both of alkylene and PAV/AE residues, and optionally CSM residue(s). In an FKM fluoroelastomer hereof, the content of TFE is typically 15 mol. % or more, generally 20, 25, 30, 35, 40, 45, or 50 or more; typically 85 mol. % or less, or less than or equal to 80% or 75%. In various embodiments, the TFE content can be from about 15 to about 85 mol. % TFE, or from about 25 to about 80 mol. %, or from about 50 to about 75 mol. %. In PAV/AE-containing fluoroelastomer polymers hereof, the mole ratio of TFE:PAV/AE is typically from about 40:60 to about 90:10.

### FFKM

As used herein, “FFKM” fluoroelastomer refers to those fluoroelastomers belonging to the ASTM “FFKM” designation, and particularly those that comprise TFE and PAV/AE residues, typically PAVE residues, with from 30 to 87% mol. % TFE, but that are generally free of VDF and alkylene residues. From 42 to 80 mol. % PAV/AE is typically present therein. In FFKM fluoroelastomers hereof, the mole ratio of TFE:PAV/AE is typically from about 40:60 to about 90:10. In some embodiments, the FFKM fluoroelastomer can contain cure site monomer residue(s). In various embodiments, the FFKM fluoroelastomer can contain only TFE and PAV/AE monomer residues, and optionally CSM residue(s). “FFKM-class” fluoroelastomers hereof include perfluoroalkylpolyethers, generally free of VDF and alkylene residues, that contain cure-site monomer(s); in various embodiments, these exhibit performance characteristics within the ranges of those exhibited by FFKM fluoroelastomers. In some embodiments of FFKM-class fluoroelastomers, the CSM can be a terminal silicone group(s), such as is found in silicone-crosslinking-group-terminated perfluoroalkylpolyethers, e.g., Sin-etsu Sifel. Silicone CSMs are further described below in the discussion of CSMs.

### FEPM

As used herein, “FEPM” fluoroelastomer refers to those fluoroelastomers belonging to the ASTM “FEPM” designation, and particularly those that comprise TFE and alkylene residues, with at least 50 mol. % TFE, but that are generally free of VDF residues. The alkylene types useful in FEPM fluoroelastomers is as described above for FKM fluoroelastomers; in various embodiments, the alkylene content of FEPM is also as described therein. In some embodiments, the FEPM fluoroelastomer can contain cure site monomer residue(s). In various embodiments, the FEPM fluoroelastomer can contain only TFE and alkylene monomer residues, and optionally CSM residue(s). “FEPM-class” fluoroelastomers hereof include TFE-alkylene-PAV/AE fluoropolymers, which are generally free of VDF residues; in various embodiments, these exhibit performance characteristics within the ranges of those exhibited by FEPM fluoroelastomers. In some embodiments, the FEPM-class fluoroelastomer can contain cure site monomer residue(s). In various embodiments, the FEPM-class fluoroelastomer can contain only TFE, alkylene, and PAV/AE monomer residues, and optionally CSM residue(s). One useful example of an FEPM-class fluoroelastomer is DuPont Viton ETP.

### Other Monomers

In some embodiments, FKM, FFKM, and FEPM polymers can further comprise residues of other non-CSM perfluoro-monomers, e.g., perfluoro-alkyldiol residues, HFP residues, and the like. Such other monomers, where used, are typically present in an amount that is collectively about 20, 15, 10, or 5 mol. % or less, and at least or about 0.1, 0.5, 1, 2, 3, or 5 mol. %.

Representative examples of useful fluoroelastomers include those listed in Table 3.

TABLE 3
Exemplary Fluoroelastomers*

| ASTM | | |
|---|---|---|
| Type | Fluoroelastomer (Family: Example) | Exemplary Commercial Type(s) |
| FKM | Poly(TFE-co-VDF-co-E/P): | |
| | Poly(TFE-co-VDF-co-P) | AGC AFLAS M ® or AFLAS S ®; |
| | | DuPont VITON TBR-501C ® or VITON |
| | | IBR-401C ® |
| FKM | Poly(TFE-co-VDF-co-PAV/AE): | |
| | Poly(TFE-co-VDF-co-PMVE) | DuPont VITON GLT ®, VITON GFLT ®, |
| | | or VITON GBLT ® |
| FKM | Poly(TFE-co-VDF-co-E/P-co-PAV/AE): | |
| | Poly(TFE-co-VDF-co-E-co-PMVE) | |
| FFKM | Poly(TFE-co-PAV/AE): | |
| | Poly(TFE-co-PMVE) | DuPont KALREZ ®; Greene Tweed |
| | | CHEMRAZ ®; PPE PERLAST ® |
| FEPM | Poly(TFE-co-E/P): | |
| | Poly(TFE-co-P) | AGC AFLAS 100 ® or AFLAS 150 ®; |
| | | DuPont VITON TBR ®; Greene Tweed |
| | | FLUORAZ; Dyneon BRE ® or FLUOREL |
| | | II ® |
| FEPM- | Poly(TFE-co-E/P-co-PAV/AE): | |
| class | Poly(TFE-co-E-co-PMVE) | DuPont VITON ETP ® |
| FFKM- | Silicone-crosslinking-group-terminated perfluoroalkylpolyethers: | |
| class | Silicone-crosslinking-group- | Shin-Etsu SIFEL ® |
| | terminated perfluoroisopropylpolyethers | |

*These polymers include versions thereof in which a cure-site monomer residue(s) is also present. Company names: AGC = Asahi Glass Co., Ltd (Tokyo, JP); DuPont (Wilmington, DE, US); Greene Tweed & Co. Ltd. (Nottingham, UK); PPE = Precision Polymer Engineering Ltd. (Blackburn, UK); Shin-Etsu Chemical Co., Ltd. (Tokyo, JP)

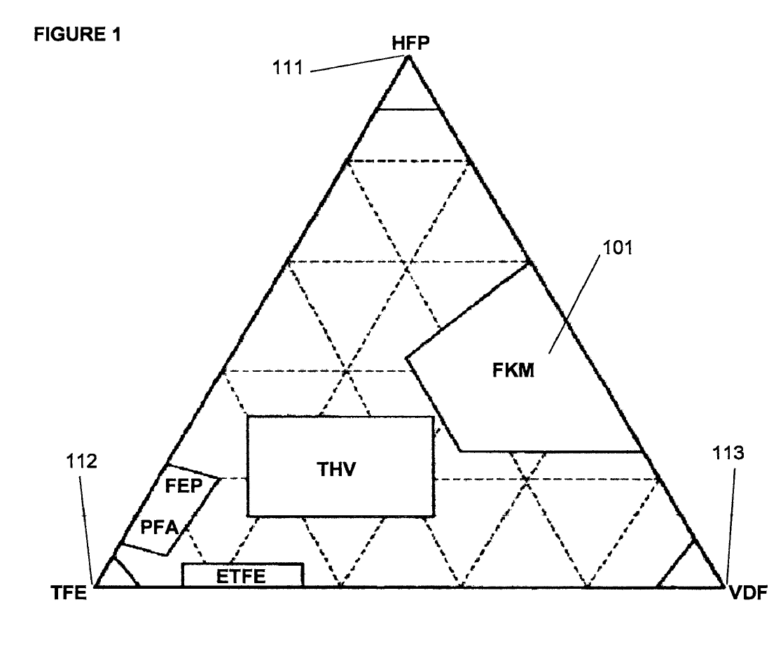

Further examples of useful FKM fluoroelastomers include: DAI-EL® (e.g., Dai-El G999; Daikin Industries, Ltd., Osaka, JP), TECNOFLON® (Solvay-Solexis S.p.A., Bollate, Mich., IT), NOXTITE® (UNIMATEC Chemicals Europe GmbH & Co. KG, Weinheim, Del.), FLUOREL® and DYNEON® (e.g., Dyneon FC, FE, FG, FT, and FX grades; 3M Dyneon LLC, Oakdale, Minn., US). As used herein “FKM fluoroelastomers” are distinguished from “HFP-VDF FKM” fluoropolymers, which can be used in some embodiments hereof. “HFP-VDF FKM” are defined herein as fluoropolymers whose compositions fall within region 101 of FIG. 1, and that can optionally further contain up to about 20, 10 or 5 mol. %, and/or at least or about 0.1, 0.2, 0.3, 0.5, or 1 mol. %, of other monomers (whether CSM and/or non-CSM monomers), in which case the mole ratio of HFP:VDF or of HFP:VDF:TFE is unchanged.

Further examples of useful FFKM perfluoroelastomers include, PAROFLUOR® (Parker Hannifin Corp., Mayfield Heights, Ohio, US), SIMRIZ® (Freudenberg-NOK, Plymouth, Mich., US), and ZALAK® (DuPont). Additional examples of useful fluoroelastomers include those described in US Publication No. 2007/0004862 to Park et al.

### Cure-Site Monomers

Cure-site monomers (CSM) can be used herein to cross-link polymer chains of fluoroelastomers. Useful CSMs are those monomers that, after incorporation into the polymer chain and prior to vulcanization/cross-linking, contain substituent groups that can be cross-linked by chemical reaction. Examples of such useful substituent groups include those that are unsaturated, e.g., vinyl, nitrile, or isocyanate groups; or that contain chlorine, iodine, or bromine (typically iodine or bromine); or that contain an epoxy group (e.g., an oxiranyl or glycidyl group), a hydroxy group, or another chemically reactive moiety; or a thio-replaced version of any of the foregoing oxy-containing groups, such as thiocyanate, isothiocyanate, thioepoxy, or thiol. Acryl and methacryl groups can be used in some embodiments as unsaturated substituent group(s) in a CSM. In various embodiments, the CSM(s) can be polyfluorinated monomers comprising such chemically reactive groups, and in some embodiments, the reactive group itself can include fluorine (e.g., fluorooxiranyl or di-, tri-, or tetra-fluoroglycidyl groups).

The remainder of the CSM residue can be, e.g., a two-to-six skeletal atom hydrocarbon, heterohydrocarbon, or silane, or a fluorinated or perfluorinated version thereof, wherein skeletal atoms are those at least divalent atoms of the main chain other than substituents (including hydrogen substituents); skeletal atoms can be, e.g., C, Si, O, or S. In various embodiments, a cure site monomer skeleton can contain up to 8, or up to 6, or up to 4 carbon atoms.

In some embodiments, a halo-hydrocarbon can be used as the CSM, e.g., halo-difluoroethylene, halo-trifluoroethylene, 3-halo-perfluoropropene, 4-halo-tetrafluorobutene, and the like, in which the halo group is I or Br, though in some embodiments C1 can be selected as the halo group. Cure site monomers who skeletons are unsaturated can, and typically do, have at least one such unsaturation in a terminal position, for use in reaction with the growing polymer chain. In various embodiments, other type(s) of cure-site monomer(s) can be used, e.g., cognates of the above-listed haloalkenes in which the bromo- or iodo-group is replaced by a different cross-linkable group, e.g., a nitrile-containing group.

One or more than one type of CSM can be present in a given fluoropolymer, though typically only one type is selected. CSMs can be present in fluoropolymers hereof at an average frequency of about 1 or 2 CSM per polymer chain, and, where used, can be present at up to or about 5, 3, 2, or 1 mol. %. Typically, CSM-containing fluoropolymers can comprise the CSM residues at a concentration of at least or about 0.05, 0.1, 0.2, 0.3, or 0.5 mol. %. In some embodiments in which a bromine or iodine-type cure-site monomer is used, the cure-site monomer residues can be present at a level sufficient to provide about 0.05% by weight or more of these halogen(s) in the polymer, or 0.3% or more; and in some embodiments 1.5 wt. % or less. The CSM residues can be regularly or randomly located in the polymer chain, and can be terminal or internal, or both, to the main backbone chain of the polymer. Where a silane-type CSM is selected, e.g., a fluoroalkyl or perfluoroalkyl siloxane CSM, for use herein, it is typically used in a terminal position. Various useful types of CSM, and chemical cross-linking reactions therefore, include those described in: U.S. Pat. Nos. 6,359,089 and 6,437,066 to Hung et al. (fluoroalkylvinyl and fluoroalkoxyvinyl ethers); U.S. Pat. Nos. 6,844,388 and 7,019,083 to Grootaert et al. (nitrites, amidines, imidates); U.S. Pat. No. 6,864,336 to Kaspar (halohydrocarbons); U.S. Pat. No. 6,927,259 to Schmiegel (fluoroalkylethylenes, fluoroalkoxyethylenes, and halo-substituted versions thereof); and U.S. Pat. No. 7,083,856 to Rajagopalan et al. (silanes); and US 2006/0201613 to Minowa et al. (nitrites).

The CSM-containing and CSM-free fluoropolymers hereof can be prepared by polymerization of the stated monomers according to any of the conditions and techniques known useful therefor in the art. CSM residues in CSM-containing fluoropolymers hereof can be cured using curing agents, such as those described below; yet, CSM-containing polymers can alternatively, or in addition, be cured using a cross-linking dose of radiation.

### Curing Agents and Curing Systems

Cross-linking reactions of cure-site monomer residues can be initiated by contact under elevated temperature with a curing agent, such as any of the organic peroxide, aliphatic polyol (e.g., diol), aromatic polyol (e.g., polyphenol, such as bisphenol), or polyamine (e.g., diamine) curing agents known in the art, or a combination thereof. A curing system can utilize an organometallic curing agent or an onium salt, e.g., an aliphatic or aromatic ternary phosphonium or sulfonium halide or quaternary ammonium halide, which can be used, e.g., with a phenolic curing agent.

Fluoropolymers, particularly fluoroelastomers hereof, that contain CSM residues are typically cured by use of such a curing agent. The choice of curing agent will depend in part on the nature of the reactive group(s) of the cure-site monomer residues, as is well known to one of ordinary skill in the art. Typically, a peroxide curing agent can be selected for use in curing Br/1-type CSM-residue containing polymers, some examples of which include, bis(2,4-dichlorobenzoyl) peroxide, di-benzoylperoxide, di-cumyl peroxide, di-tertiary butyl peroxide, and 2,5-dimethyl-2,5-bis(t-butyl peroxy) hexane. Peroxides can also be used to cure other types of CSM residues herein.

Other examples of useful curing agents include: (1) organometallic curing agents, such as organotin agents, e.g., tetraalkyltin compounds and tetraaryltin compounds, one example of which is tetraphenyl tin; (2) onium salts of bisphenol anions, such as alkali metal, quaternary ammonium, tertiary sulfonium, quaternary phosphonium, and other salts thereof; (3) diamino compounds, such as bisamines and aromatic diamino compounds, examples of which include bisaminophenols (e.g., 2,2-bis[3-amino-4-hydroxyphenyl] hexafluoropropane) and bisaminothiophenols; (4) tetraamines; (5) bisamidrazones; and (6) bisamidoximes. Bisamine and bisphenol curing agents can be used to cure fluoroelastomers in which no CSM is present, although a higher concentration of curing agents and harsher conditions are typically needed than in the case of CSM-containing polymers, and a post-treating step of oven heating is employed to maximize bonding, which step is not needed in processing CSM-containing polymers. In some embodiments hereof, a peroxide- or bisphenol-type curing agent can be used, or a combination thereof.

In some embodiments, a fluoropolymer composition hereof can be cured using a multi-component curing system that can contain any one or more of, e.g., co-curing agents, cross-linking agents, activators, accelerators, and other curing- or vulcanization-enhancing additives, in addition to the primary curing agent(s). For example, a curing system hereof can further comprise an acid acceptor, e.g., magnesium oxide, calcium oxide, calcium hydroxide, zinc oxide, or a combination thereof. Additional examples of useful cure-enhancing additives and curing systems include those described, e.g., in US 2004/0236028 to Hung, US 2004/0214944 to Tomihashi et al., and US 2007/0044906 to Park. Useful elevated temperatures are described below in the discussion of processing.

### Other Additives

Other additives that can be included in a fluoroelastomer, fluorothermoplastic, or composite material hereof are any known useful in the polymer arts. Examples of such additives include: processing aids (e.g., surfactants, lubricants, plasticizers, mold-release agents), colorants (e.g., pigments, dyes), fillers (e.g., carbon black, graphite, silica, talc, clay, diatomaceous earth, calcium carbonate, inert polymeric particulate, such as PTFE particulate, fluorosilicones), anti-static agents (e.g., conductive inorganic particulate, conductive polymers), stabilizers (e.g., UV light stabilizers), and anti-degradants (e.g., anti-oxidants).

In various embodiments, curing agents and other additives can be added to the fluoroelastomer or to the fluorothermoplastic polymer(s), or both, prior to formation of the mixture that will be treated to form the thermoplastic vulcanizate.

### Processing

To prepare a thermoplastic vulcanizate, the fluoroelastomer and fluorothermoplastic polymers are combined, along with any desired curing agent(s) or other additives, and the combination is brought to an elevated temperature that is sufficient to increase the plasticity of the combination enough to permit physical mixing (e.g., mastication). In various embodiments, the temperature can be at or above the Vicat softening point of the thermoplastic (which can be determined according to ASTM D1525) and below the lowest decomposition temperature (Td) among the fluoropolymers in the combination, and below the Td of the thermoplastic vulcanizate. In various embodiments, a fluorothermoplastic can be used that has a softening temperature (Ts) or a melt temperature (Tm) in the range from about 80 to about 375° C., typically from about 120, 150, or 170° C. to about 300, 310, or 320° C.

Heating and mixing (e.g. masticating) a curing agent-curable composition hereof at vulcanization temperatures is generally sufficient to obtain a completed vulcanization reaction in a few minutes or less; if still shorter vulcanization times are desired, higher temperatures and/or higher shear may be used. A suitable range of vulcanization temperature is from about the melting temperature of the thermoplastic material to about 350° C., or typically from about 120° C. to about 300° C., about 150° C. to about 250° C., or about 180° C. to about 220° C. Generally, the mixing is constantly maintained until a desired degree of vulcanization occurs.

As noted, the combination is processed by mixing and curing. The mixing (e.g., mastication) generally causes the fluoroelastomer to disperse into the fluorothermoplastic. Where the mixing at elevated temperature also causes vulcanization of the fluoroelastomer, the process is referred to as a dynamic vulcanization. The mixing, and/or the dynamic vulcanization, can be performed as a batch or continuous process. Thus, the process can utilize, e.g., a roll mill; a kneader such as a dispersion kneader; a Moriyama mixer, Banbury mixer, or Brabender mixer; a continuous mixer; or a mixing extruder such as roll extruder, or a single- or twin-screw extruder. In various embodiments, mixing is performed by transferring the combination into a roll or screw extruder that shears the fluoroelastomer, thereby decreasing the average size of the fluoroelastomer regions and increasing the degree of dispersion thereof in the fluorothermoplastic. Where a curing agent for the fluoroelastomer is present in the mixture, vulcanization take place during the mixing and extrusion, a technique referred to as “dynamic vulcanization.”

In various embodiments, mixing is allowed to proceed until the regions of dispersed fluoroelastomer have a range of diameters in which the largest regions are generally about 50 μm or less in average diameter. In some embodiments, the fluoroelastomer regions will have a range of diameters such that 90% or more of the regions will have sizes within about 0.01-50 μm, or about 0.01-25 μm, 0.01-20 μm, 0.01-10 μm, 0.01-5 μm, or 0.01-3 μm. In some embodiments all or substantially all of the fluoroelastomer regions can fall within such a size range.

The fluoroelastomer can be fully or partially vulcanized. In some embodiments, the fluoroelastomer is partially vulcanized. “Partially vulcanized” refers to the state of an elastomer that has been vulcanized sufficiently so as to exhibit a compression set value (ASTM D395) that is less than that of the non-vulcanized elastomer by at least or about 50% of the difference between the compression set values of the non-vulcanized elastomer and a fully-vulcanized form of that elastomer. In some embodiments, the partial vulcanization can be determined as a compression set value less than a non-vulcanized compression set value by at least or about 60, 70, 80, 90, or 95% of this difference. Partial vulcanization can also be determined by extraction in boiling xylene, wherein a partially vulcanized sample is one in which more than 5 wt. % of the crosslinkable elastomer is extractable; and in which up to or about 20, 30, 40, or 50 wt. % of the crosslinkable elastomer is extractable. See the technique set forth in U.S. Pat. No. 4,311,628 to Abdou-Sabet et al.

After mixing, the composition, which can be a thermoplastic vulcanizate, can be shaped into the form of an article, or into the form of a block to be further shaped after cooling or further processing. The composition can be cooled to about room temperature. If vulcanization has been proceeding during the mixing, e.g., a dynamic vulcanization, then the cooling step can comprise continued mixing of the composition.

After the mixing process, and typically after the cooling process, is complete, the composition can be cross-linked, or further cross-linked, by exposing it to radiation, such as electron beam or gamma radiation, in an amount of 1 MRad to about 40 MRad, more typically of from about 5 MRad to about 20 MRad, e.g., as described in US Publication No. 2006/0004142 to Park et al. In various embodiments, the irradiation step can be performed on the, e.g., shaped and/or cooled, composition that has been placed under vacuum or inert gas (e.g., argon or nitrogen) to remove oxygen from the environment of the composition; the conditions of low oxygen can be maintained during the radiation in order to minimize possible radiation-induced degradation and thereby enhance radiation-induced cross-linking. The radiation induces cross-links in the fluorothermoplastic matrix and can induce cross-links in the fluoroelastomer and between the elastomer and the fluorothermoplastic. Prior to irradiation, the irradiated material, or the shaped articles of the material, are rubber-like materials that, unlike conventional rubbers, can be processed and recycled like thermoplastic materials. Such a material can be used to form a shape article by any method known useful in the art, e.g., inection molding, compression molding, cutting, abrading, and so forth. Following irradiation, the material, or the shaped article, behaves more like a thermoset plastic.

### Properties of the Processed Materials

The composite materials hereof exhibit an enhanced degree of resistance to polar organic solvents, such as ketones-type and/or alcohol-type solvents. In some embodiments, these materials exhibit 10, 20, or 30% more solvent resistance than the same material before processing. Tests for determining solvent resistance include swell ratio measurement, performed according to procedures outlined in ASTM F2214-02 for cross-linked polyethylene, substituting the polymeric materials and solvents described herein. In some embodiments, a swell ratio tester can be employed, such as the SRT device (Cambridge Polymer Group, Inc., Boston, Mass., US), operated according to manufacturer's instructions.

As used herein, a “ketone-type solvent” refers to a solvent containing about 40% or more, or about 50, 60, 70, 80, or 90% or more, by volume of any one or more of the C₃-C₉ ketones, particularly ketones comprising n-alkyl, iso-alkyl, and/or sec-alkyl groups, and less preferably those containing tert-alkyl, neo-alkyl, or more highly branched alkyl groups; particularly useful ketones are C₃-C₆ ketones comprising, as alkyl groups, only n-alkyl and/or iso-alkyl groups, examples thereof being acetone, methyl-ethyl ketone (MEK), diethyl ketone (DEK), and methyl-isobutyl ketone (MIBK). In a “ketone-type solvent” hereof, the non-ketone component(s) of the solvent, when present, comprises aromatic and/or aliphatic hydrocarbons, with homohydrocarbons being especially useful. In various embodiments, such hydrocarbons contain about 10 or fewer carbon atoms. Examples of useful hydrocarbons include C1-C10 alkanes and olefins, e.g., C₃-C₈ alkanes; C₆-C₁₀ aromatics, e.g., benzene, toluene, xylenes; and combinations thereof.

Examples of ketone solvents useful herein include the C₃-C₅ alkyl ketones such as acetone (DMK), methyl ethyl ketone (MEK), diethyl ketone (DEK), methyl n-propyl ketone (MPK), and methyl isopropyl ketone (MIPK). Other useful ketone solvents include C₆-C₁₀ ketone solvents in which the alkyl substituents on the ketone (C═O) group are C₁-C₆ n-, iso-, or sec-alkyl. In some embodiments, n- and iso-alkyl substituents can be used. In various embodiments, at least one of the alkyl substituents can be n-alkyl; in some embodiments, at least one of the alkyl substituents can be methyl or ethyl. In various embodiments, the alkyl substituents can be chosen from among methyl, ethyl, n-propyl, isopropyl, n-butyl, isobutyl, and sec-butyl; in some embodiments, n-amyl or isoamyl can be used as an alkyl substituent. In some embodiments, a C6 or C7 ketone can be selected as the C₆-C₁₀ ketone solvent. Some examples of useful C₆-C₁₀ ketone solvents include: methyl n-butyl ketone (MBK), methyl isobutyl ketone (MIBK), sec-butyl methyl ketone (SBMK), ethyl n-propyl ketone (EPK), ethyl isopropyl ketone (EIPK), methyl n-amyl ketone (MAK), methyl isoamyl ketone (MIAK), methyl n-hexyl ketone (MHK), and methyl isohexyl ketone (MIHK).

As used herein, an “alcohol-type solvent” refers to a solvent containing at least 5% or about 10 or 15% or more by volume of any one of methanol or ethanol or combinations thereof; in various embodiments, an “alcohol-type solvent” can comprise at least or up to about 25%, 50%, 75%, 85%, 90%, or 95% alcohol, or up to about 100% alcohol. In an “alcohol-type solvent” hereof, the non-ketone component(s) of the solvent, when present, comprises aromatic and/or aliphatic hydrocarbons, as defined above for use in “ketone-type” solvents.

In some embodiments, a mixed solvent can be used that contains both ketone(s) and alcohol(s). In order to prepare solvent mixtures useful herein, in various embodiments, mineral spirits can be used to provide combinations of aromatic and aliphatic hydrocarbons, such as alkyl benzenes, alkanes, isoparaffins and cycloalkanes, and other petroleum-refining products. In various embodiments, lacquer thinner can be used to provide combinations of ketone(s) and alcohol(s), and often other useful components such as aliphatic or aromatic hydrocarbons, such as: acetone, methyl ethyl ketone, methyl isobutyl ketone; methanol, ethanol, isopropyl alcohol, glycol monoethyl ether, glycol monobutyl ether, toluol, butanol; aliphatic hydrocarbons; aromatics, such as toluene, xylene; and in some cases small amounts of esters, such as ethyl acetate, n-propyl acetate, butyl acetate, amyl acetate, 2-butoxyethanol, or isobutyl isobutyrate.

In various embodiments, the improvement in resistance to swelling in a ketone, alcohol, or mixed solvent can be determined for a radiation cross-linked composite material, or a radiation cross-linked thermoplastic vulcanizate hereof, compared to the value for that same material in its pre-irradiated form.

### EXAMPLES

### Example 1

Thermoplastic vulcanizates are prepared from combinations selected from Table 4.

TABLE 4
Thermoplastic vulcanizate components

| | |
|---|---|
| FKM Elastomers | ETP, GFLT, AFLAS, TBR, G999, and mixture thereof |
| Fluorinated | PVDF, ETFE, ECTFE, THV, and mixture thereof |
| Plastics | |
| Curative Package | Peroxide, Bisphenol, and mixture thereof |

A series of thermoplastic vulcanizates (TPV) are prepared from blends of AFLAS ETP 600S and PVDF. These are treated in immersion tests in various solvents at room temperature. Various properties are measured for the TPV (having the indicated wt. % of fluoropolymer components) and for comparative examples. Measured properties include: tensile strength (TS), tensile modulus at 100% elongation (M100), tensile modulus at 50% elongation (M50), elongation at break (EB), and hardness (Shore A). Results for controls are presented in Table 5.

TABLE 5
Control Values for AFLAS, PVDF, and AFLAS:PVDF TPV Blends

| | 100% Aflas | | | | | | 100% |
|---|---|---|---|---|---|---|---|
| Property | ETP 600S | 80/20* | 67/33* | 57/43* | 50/50* | 44/56* | PVDF |
| TS (MPa) | 19 | 6.6 | 12.5 | 14.6 | 18.2 | 20.9 | 48 |
| M50 (MPa) | 4 | 5.8 | 11.8 | 14.3 | 18 | 20.7 | — |
| M100 (MPa) | 9.1 | 6.5 | 12.5 | — | — | — | — |
| EB (%) | 191 | 109 | 94 | 75 | 72 | 72 | 10 |
| Hardness | 80 | 90 | 93 | 95 | 95 | 96 | 96 |

Fluid immersion tests are performed using MEK, acetone, mineral spirit, lacquer thinner, and toluene. Results are presented in Tables 6-10.

TABLE 6
Results of Fluid Immersion Test of 168 hours in MEK

| | ETP 600S | 80/20* | 67/33* | 57/43* | 50/50* | 44/56* | PVDF |
|---|---|---|---|---|---|---|---|
| TS (%) | — | −74 | −54 | −47 | −38 | −28 | — |
| M50 (%) | −49 | — | — | −46 | −40 | −35 | — |
| M100 (%) | — | — | — | — | — | — | — |
| EB (%) | 6 | −71 | −51 | −31 | −10 | 15 | 584 |
| Hardness (%) | −13 | −38 | −12 | −9 | −4 | −4 | 0 |
| Volume (%) | 18 | 77 | 48 | 45 | 43 | 41 | 4 |

TABLE 7
Results of Fluid Immersion Test of 168 hours in Acetone

| | ETP 600S | 80/20* | 67/33* | 57/43* | 50/50* | 44/56* | PVDF |
|---|---|---|---|---|---|---|---|
| TS (%) | — | −73 | −53 | −48 | −39 | −33 | — |
| M50 (%) | — | — | −51 | −49 | −44 | −41 | — |
| M100 (%) | — | — | — | — | — | — | — |
| EB (%) | — | −67 | −43 | −22 | 4 | 21 | 679 |
| Hardness (%) | — | −38 | −15 | −11 | −5 | −4 | — |
| Volume (%) | — | 58 | 50 | 49 | 37 | 48 | 30 |

TABLE 8
Results of Fluid Immersion Test of 168 hours in Mineral Spirit

| | ETP 600S | 80/20* | 67/33* | 57/43* | 50/50* | 44/56* | PVDF |
|---|---|---|---|---|---|---|---|
| TS (%) | — | −13 | −7 | 0 | −2 | 0 | 0 |
| M50 (%) | — | −9 | −6 | 1 | −2 | 0 | — |
| M100 (%) | — | — | — | — | — | — | — |
| EB (%) | — | −21 | −12 | −19 | −5 | 5 | 5 |
| Hardness (%) | — | −2 | −1 | −3 | −1 | −4 | 0 |
| Volume (%) | — | 0 | 3 | 1 | 2 | −2 | 1 |

TABLE 9
Results of Fluid Immersion Test of 168 hours in Lacquer Thinner

| | ETP 600S | 80/20* | 67/33* | 57/43* | 50/50* | 44/56* | PVDF |
|---|---|---|---|---|---|---|---|
| TS (%) | — | −63 | −38 | −34 | −24 | −19 | — |
| M50 (%) | — | — | −35 | −33 | — | −24 | — |
| M100 (%) | — | — | — | — | — | — | — |
| EB (%) | — | −61 | −39 | −29 | −12 | 17 | 63 |
| Hardness (%) | — | −25 | −5 | −4 | −1 | −1 | — |
| Volume (%) | — | 51 | 37 | 28 | 16 | 19 | 3 |

TABLE 10
Results of Fluid Immersion Test of 168 hours in Toluene

| | ETP 600S | 80/20* | 67/33* | 57/43* | 50/50* | 44/56* | PVDF |
|---|---|---|---|---|---|---|---|
| TS (%) | — | −56 | −34 | −29 | −18 | −12 | 1 |
| M50 (%) | — | — | −31 | −28 | −20 | −14 | — |
| M100 (%) | — | — | — | — | — | — | — |
| EB (%) | — | −59 | −40 | −28 | −8 | 11 | 12 |
| Hardness (%) | — | −18 | −2 | −1 | −1 | −2 | 3 |
| Volume (%) | — | 36 | 21 | 23 | 14 | 9 | 0 |

### Example 2

Fluid immersion tests are also performed on the fluorothermoplastic (“FKM-terpolymer”), fluoroelastomers, and TPV blends thereof. The tests are performed using common fuels and industrial solvents at the indicated temperatures: ASTM Reference Fuel C (50/50 toluene and iso-octane) at 100° C., biodiesel fuel at 40° C., diesel fuel at 65° C., E85 fuel (85% denatured fuel ethanol and 15% gasoline) at 40° C., hexane at 70° C., 50% concentrated H₂SO₄ at 70° C., methanol at 24° C., 1 M NaOH at 65° C., SKYDROL® (fire resistant hydraulic fluid containing butyl- and phenyl-substituted ternary phosphates, and 2-ethylhexyl-7-oxabicyclo[4.1.0]heptane-3-carboxylate, available from Solutia, Inc., St. Louis, Mo., US) at 150° C., toluene at 24° C., and trichloroethylene at 70° C.

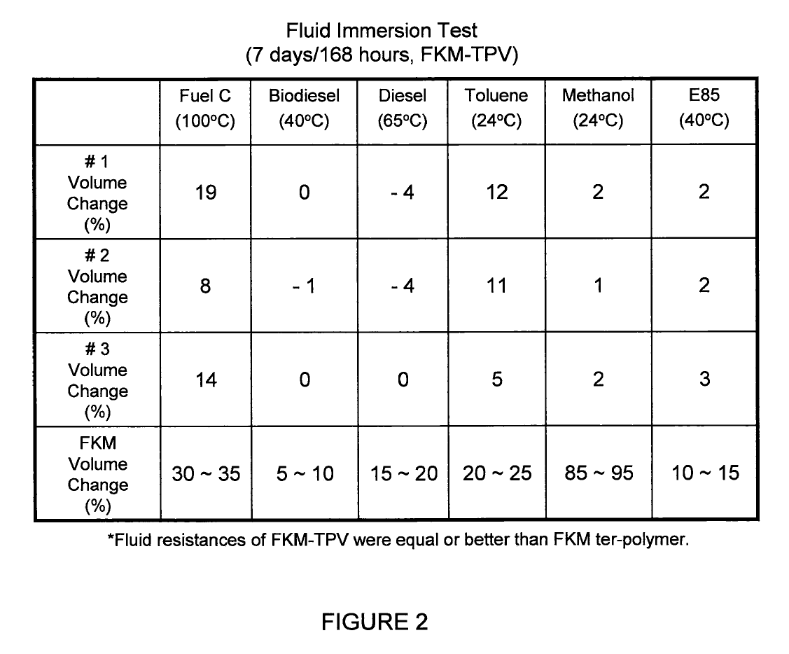

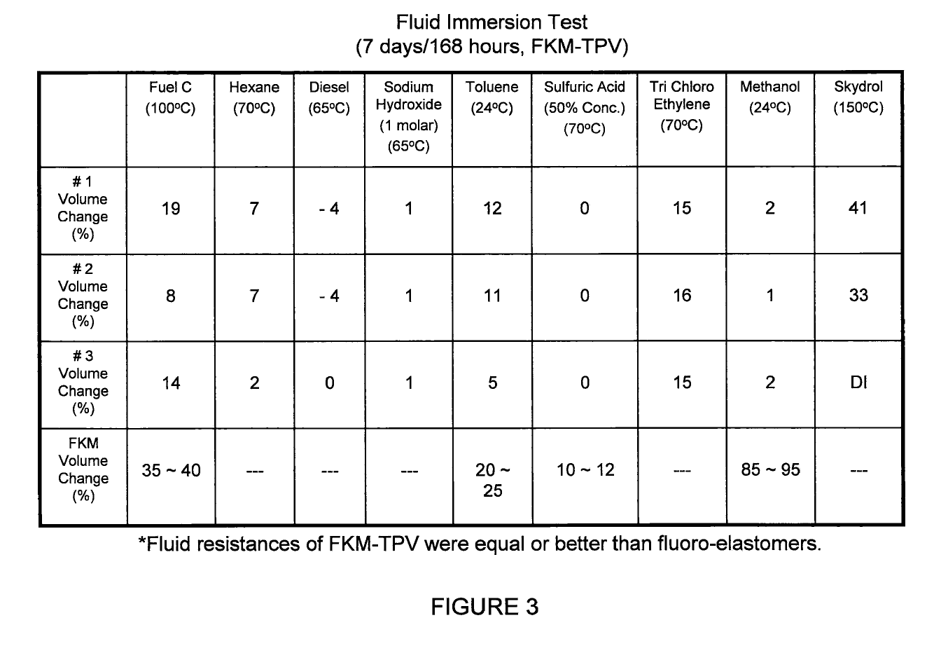

Results are shown in FIGS. 2 and 3. These data indicate that TPV according to various embodiments described herein can provide significantly improved solvent resistance in various commercial applications, including industrial spray painting, fuel transfer systems, and chemical handling and storage apparatus. Other embodiments may be apparent to one of ordinary skill in the art upon reading the present disclosure. Such other embodiments are intended to fall within the scope of the present application.

What is claimed is:

1. A ketone-solvent-resistant FKM-TPV blend comprising:
(A) from about 35% to 99% by weight of fluorothermoplastic matrix and, dispersed therein, from 1% to about 65% by weight of fluoroelastomer regions of about 50 um or less in average size,
(1) the fluorothermoplastic matrix comprising
(a) one or more fluorothermoplastic polymer, having from about 45% to about 75% by weight fluorine content and at least 40% crystallinity, that is selected from the group consisting of: thermoplastic copolymers of any of TFE, HFP, CTFE, CPFP, and VDF with one another, with PAVE, E, and/or P, and with both; and thermoplastic PVDF; and
(b) one or more additive(s) that provide a total of from 0% to about 20% by weight of the fluorothermoplastic matrix;
(2) the fluoroelastomer regions each independently comprising
(a) one or more fluoroelastomeric polymer having from about 60% to about 75% by weight fluorine content that is selected from the group consisting of elastomeric copolymers of any of TFE, PAVE/AE, and VDF with one another, with E and/or P, with one or more cure-site monomer, and with a combination thereof; and
(b) one or more fluoroelastomer additive(s) that provide a total of from 0% to about 20% by weight of the fluoroelastomer region; and
(B) one or more FKM-TPV blend additive(s) that provide a total of from 0% to about 20% by weight of the FKM-TPV blend;
wherein said blend exhibits less than 20% swelling during immersion in a ketone-type solvent at 20° C., for 7 days.

2. The blend according to claim 1, wherein the fluorothermoplastic polymer is any one of the thermoplastic poly(TFE-co-HFP) (“FEP”), poly(TFE-co-PAVE), poly(TFE-co-E/P), poly(CTFE-co-E/P), poly(CPFP-co-E/P), poly(HFP-co-E/P), poly(TFE-co-HFP-co-VDF), and PVDF polymers, and combinations thereof.

3. The blend according to claim 2, wherein the poly(TFE-co-E/P) is a poly(ethylene-co-tetrafluoroethylene) (“ETFE”) thermoplastic polymer and the poly(CTFE-co-E/P) is a poly(ethylene-co-chlorotrifluoroethylene) (“ECTFE”) thermoplastic polymer.

4. The blend according to claim 1, wherein the fluorothermoplastic polymer comprises any one of the FEP thermoplastic polymers, the poly(TFE-co-PAVE) thermoplastic polymers, and combinations thereof

5. The blend according to claim 1, wherein the fluorothermoplastic polymer comprises a poly(TFE-co-PAVE) thermoplastic polymer that is any one of the poly(tetrafluoroethylene-co-perfluoromethyl vinyl ether) (MFA) thermoplastic polymers, poly(tetrafluoroethylene-co-perfluoropropyl vinyl ether) (PFA) thermoplastic polymers, and combinations thereof.

6. The blend according to claim 1, wherein the fluoroelastomeric polymer comprises any one of the cure-site-monomer-residue-free poly(TFE-co-VDF-co-E/P), poly(TFE-co-E/P), poly(TFE-co-VDF-co-PAVE/AE), poly(TFE-co-PAVE/AE), poly(TFE-co-VDF-co-PAVE/AE-co-E/P), and poly(TFE-co-PAVE/AE-co-E/P) fluoroelastomeric copolymers, the cure-site-monomer-residue-containing poly(TFE-co-VDF-co-E/P), poly(TFE-co-E/P), poly(TFE-co-VDF-co-PAVE/AE), poly(TFE-co-PAVE/AE), poly(TFE-co-VDF-co-PAVE/AE-co-E/P), and poly(TFE-co-PAVE/AE-co-E/P) fluoroelastomeric copolymers, and combinations thereof.

7. The blend according to claim 6, wherein the poly(TFE-co-VDF-co-E/P) is a poly(tetrafluoroethylene-co-vinylidene fluoride-co-propylene) fluoroelastomeric copolymer, the poly(TFE-co-E/P) is a poly(tetrafluoroethylene-co-propylene) fluoroelastomeric copolymer, the poly(TFE-co-VDF-co-PAVE/AE) is a poly(tetrafluoroethylene-co-vinylidene fluoride-co-perfluoro(methyl vinyl ether)) fluoroelastomeric copolymer, the poly(TFE-co-PAVE/AE) is a poly(tetrafluoroethylene-co-perfluoro(methyl vinyl ether)) fluoroelastomeric copolymer, the poly(TFE-co-VDF-co-PAVE/AE-co-E/P) is a poly(tetrafluoroethylene-co-vinylidene fluoride-co-ethylene-co-perfluoro(methyl vinyl ether)) fluoroelastomeric copolymer, and the poly(TFE-co-PAVE/AE-co-E/P) is a poly(tetrafluoroethylene-co-ethylene-co-perfluoro(methyl vinyl ether)) fluoroelastomeric copolymer.

8. The blend according to claim 1, wherein the blend comprises about 35% to about 50% by weight of the fluorothermoplastic matrix and, dispersed therein, from about 65% to about 50% by weight of the fluoroelastomer regions.

9. The blend according to claim 1, wherein the blend comprises about 50% to 99% by weight of the fluorothermoplastic matrix and, dispersed therein, from about 50% to 1% by weight of the fluoroelastomer regions.

10. The blend according to claim 1, wherein the fluoroelastomer regions comprise a cure-site-monomer-residue-containing fluoroelastomeric polymer or polymers that are cross-linked at cure-sites thereof.

11. The blend according to claim 10, wherein the cure-site-monomer-residue-containing fluoroelastomeric polymer or polymers are chemically cross-linked.

12. The blend according to claim 11, wherein the cure-site-monomer-residue-containing fluoroelastomeric polymer or polymers are peroxide cross-linked or bisphenol cross-linked.

13. The blend according to claim 10, wherein the cure-site-monomer-residue-containing fluoroelastomeric polymer or polymers are radiation cross-linked.

14. The blend according to claim 1, wherein the fluoroelastomer regions comprise a cure-site-monomer-free fluoroelastomeric polymer or polymers.

15. The blend according to claim 14, wherein cure-site-monomer-free fluoroelastomeric polymers of the dispersed regions are radiation cross-linked.

16. The blend according to claim 14, wherein cure-site-monomer-free fluoroelastomeric polymers of the dispersed regions are radiation cross-linked to fluorothermoplastic polymers of the matrix.

17. The blend according to claim 1, wherein the fluorothermoplastic polymer or polymers are cross-linked.

18. The blend according to claim 17, wherein the fluorothermoplastic polymer or polymers are radiation cross-linked.

19. The blend according to claim 1, wherein both the fluorothermoplastic polymer(s) and the fluoroelastomeric polymer(s) are cross-linked.

20. The blend according to claim 19, wherein fluorothermoplastic polymer(s) of the matrix are further cross-linked to fluoroelastomeric polymer(s) of fluoroelastomer regions.

21. A process for preparing an FKM-TPV blend according to claim 1, comprising
(A) mixing said fluorothermoplastic and fluoroelastomer with the additives, the fluoroelastomer comprising cure-site monomer residues, and the additives including curing agent(s) in contact with the fluoroelastomer, wherein the mixing is performed under an elevated temperature above the Vicat softening point of the fluorothermoplastic;
(B) continuing to mix until the average diameter of the fluoroelastomer regions is about 50 μm or less, thereby forming a mixed blend; and then
(C) irradiating the mixed blend to induce cross-links in the fluorothermoplastic, thereby forming an irradiated blend.

22. The process according to claim 21, wherein steps (A) and (B) are performed by extrusion.

23. The process according to claim 21, wherein said process further comprises shaping the mixed blend after step (B) and before step (C), to form an article.

24. The process according to claim 21, wherein said process further comprises shaping the irradiated blend after step (C), to form an article.

25. A process for preparing an FKM-TPV blend according to claim 1, comprising
(A) mixing said fluorothermoplastic and fluoroelastomer with the additives, wherein either the fluoroelastomer is cure-site monomer residue-free or the additives do not comprise a curing agent, the mixing being performed under an elevated temperature above the Vicat softening point of the fluorothermoplastic;
(B) continuing to mix until the average diameter of the fluoroelastomer regions is about 50 gm or less, thereby forming a mixed blend; and then
(C) irradiating the mixed blend to induce cross-links in the fluorothermoplastic, and in the fluoroelastomer, thereby forming an irradiated blend.

26. The process according to claim 25, wherein steps (A) and (B) are performed by extrusion.

27. The process according to claim 25, wherein said process further comprises shaping the mixed blend after step (B) and before step (C), to form an article.

28. The process according to claim 25, wherein said process further comprises shaping the irradiated blend after step (C), to form an article.

29. An article comprising an FKM-TPV blend according to claim 1.

30. The article according to claim 29, wherein said article is a molded, extruded, or cut article.

31. The article according to claim 29, wherein said article is a sheet, stopper, seal, gasket, O-ring, potting, radial shaft seal, or static seal.
